(19) United States
(12) Patent Application Publication
(10) Pub. No.: US 2025/0292233 A1
(43) Pub. Date: Sep. 18, 2025

(54) CROSS-CHAIN CRYPTOCURRENCY ABSTRACTION USING CROSS-CHAIN TRANSFER PROTOCOL

(71) Applicant: CIRCLE INTERNET FINANCIAL LIMITED, Dublin 2 (IE)

(72) Inventors: Naomi Boneh, Boston, MA (US); Gee Chuang, Boston, MA (US); Kaili Wang, Boston, MA (US)

(21) Appl. No.: 18/605,715

(22) Filed: Mar. 14, 2024

(51) Int. Cl. G06Q 20/36; G06Q 20/38

(52) U.S. Cl. CPC G06Q 20/3672; G06Q 20/3825

(57) ABSTRACT

Implementations are directed to cryptocurrency abstraction using a cross-chain transfer protocol (CCTP) between a source chain network and a destination chain network and can include receiving a user operation that indicates a paymaster and that includes an attestation, triggering, by the paymaster, minting of a number of tokens of a cryptocurrency on a destination chain, the number of tokens corresponding to a number of tokens of the cryptocurrency burned on a source chain attested to by the attestation, receiving, by the paymaster, the number of tokens of the cryptocurrency minted on the destination chain, and accounting, by the paymaster and using at least a portion of the number of tokens of the cryptocurrency, for computing resources expended on the destination chain to execute a transaction of the user operation.

### TECHNICAL FIELD

This specification relates generally to digital asset transactions and more particularly to cryptocurrency abstraction using a cross-chain transfer protocol.

### BACKGROUND

The development of distributed ledger technology has enabled a multitude of digital transactions not available in the pre-Internet world. For example, distributed ledger technology enables users to hold digital assets as stores of value and mediums of exchange with immutability and traceability. In general, a digital asset can be described as a virtual store of value that leverages a distributed ledger to store, record and validate transactions. An example digital asset includes cryptocurrencies. Distributed ledgers can be referred to as blockchains or chains.

Users can hold digital assets across multiple chains. For example, a user can hold a cryptocurrency on a source chain and a non-fungible token (NFT) on a destination chain. In some instances, a user can seek to execute a transaction on the destination chain (e.g., transferring the NFT to another user) and use the cryptocurrency of the source chain to facilitate the transaction (e.g., account for transaction fees on the destination chain). To achieve this, the user must bridge the cryptocurrency across the chains.

### SUMMARY

This specification describes systems, methods, devices, and other techniques relating to digital asset transactions. More particularly, implementations of the present disclosure are directed to using a cross-chain transfer protocol for cryptocurrency abstraction between a source chain and a destination chain.

In general, innovative aspects of the subject matter described in this specification can include actions of receiving a user operation that indicates a paymaster and that includes an attestation, triggering, by the paymaster, minting of a number of tokens of a cryptocurrency on a destination chain, the number of tokens corresponding to a number of tokens of the cryptocurrency burned on a source chain attested to by the attestation, receiving, by the paymaster, the number of tokens of the cryptocurrency minted on the destination chain, and accounting, by the paymaster and using at least a portion of the number of tokens of the cryptocurrency, for computing resources expended on the destination chain to execute a transaction of the user operation. Other implementations of this aspect include corresponding systems, apparatus, and computer programs, configured to perform the actions of the methods, encoded on computer storage devices.

These and other implementations can each optionally include one or more of the following features: a bundler retrieves the user operation from an alternative memory pool and provides the user operation to an entrypoint; a cross-chain fee abstraction contract triggers burning of the number of tokens on the source chain based on a permit signature provided by a user that owns the number of tokens on the source chain; the cross-chain fee abstraction contract transfers tokens of the cryptocurrency from an account of the user on the source chain to account for computing resources expended on the source chain; the attestation is generated by an attestation service in response to a message event provided from the source chain; a user wallet of the user receives the attestation from an attestation service and transmits the user operation to the alternative memory pool; actions further include providing, by the paymaster, one or more tokens to a user account of a user on the destination chain; and the paymaster triggers minting of the number of tokens of a cryptocurrency on the destination chain in response to a validate paymaster function called by an entrypoint.

The present disclosure also provides a non-transitory computer-readable storage medium coupled to one or more processors and having instructions stored thereon which, when executed by the one or more processors, cause the one or more processors to perform operations in accordance with implementations provided herein.

It is appreciated that the methods and systems in accordance with the present disclosure can include any combination of the aspects and features described herein. That is, methods and systems in accordance with the present disclosure are not limited to the combinations of aspects and features specifically described herein, but also include any combination of the aspects and features provided.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a conceptual architecture in accordance with implementations of the present disclosure.

FIG. 2 depicts an example architecture to facilitate cryptocurrency abstraction using a cross-chain transfer protocol (CCTP) in accordance with implementations of the present disclosure.

FIG. 3A is an example signal flow diagram for the source chain network in accordance with implementations of the present disclosure.

FIG. 3B is an example signal flow diagram for the destination chain network in accordance with implementations of the present disclosure.

FIG. 4 depicts a flowchart of an example process that can be executed in accordance with implementations of the present disclosure.

Like reference numbers and designations in the various drawings indicate like elements.

### DETAILED DESCRIPTION

The technology of this patent application is directed to facilitating digital asset transactions. More particularly, implementations of the present disclosure are directed to using a cross-chain transfer protocol (CCTP) for cryptocurrency abstraction between a source chain and a destination chain.

In some implementations, actions include receiving a user operation that indicates a paymaster and that includes an attestation, triggering, by the paymaster, minting of a number of tokens of a cryptocurrency on a destination chain, the number of tokens corresponding to a number of tokens of the cryptocurrency burned on a source chain attested to by the attestation, receiving, by the paymaster, the number of tokens of the cryptocurrency minted on the destination chain, and accounting, by the paymaster and using at least a portion of the number of tokens of the cryptocurrency, for computing resources expended on the destination chain to execute a transaction of the user operation.

To provide context for the subject matter of the present disclosure, and as introduced above, users can hold digital assets as stores of value and mediums of exchange. In general, a digital asset can be described as a virtual store of value that leverages a distributed ledger to store, record and validate transactions. A distributed ledger can be described as a decentralized database that immutably stores transactions across a peer-to-peer network. Distributed ledgers can be referred to as blockchains, or chains. Example digital assets can include, without limitation, cryptocurrencies (e.g., stablecoins), non-fungible tokens (NFTs), security tokens, and the like. Implementations of the present disclosure are described in further detail herein with reference to example digital assets, such as stablecoins and NFTs. However, it is contemplated that implementations of the present disclosure can be realized using any appropriate digital assets.

In some examples, a cryptocurrency can be described as a digital currency that uses cryptography to secure transactions that are recorded in a distributed ledger that is maintained within a peer-to-peer network. In some examples, a stablecoin can be described as a cryptocurrency having a value that is tied (pegged) to the value of a real-world, non-digital asset, such as a fiat currency, a commodity, or a financial instrument. Stablecoins are absent the volatility of other cryptocurrencies and, as such, are a useful medium of exchange. An example stablecoin includes, without limitation, USDC™.

In general, users hold digital assets on a chain and can manage digital assets using externally owned accounts (EOAs). An EOA is an account that is associated with a public key and a private key pair. A digital wallet can be described as a software application that enables users to access and transact digital assets on chains through one or more EOAs. A digital wallet executes off-chain and stores private keys of each of the one or more EOAs. An EOA can be used to initiate a transaction that is executed using a smart contract account (SCA). The SCA is maintained on-chain and executes transactions triggered by user operations (userOps).

Implementations of the present disclosure are described in further detail herein with reference to example peer-to-peer networks, each maintaining a respective chain. The example peer-to-peer networks can each be described as an Ethereum-compatible network. Ethereum can be described as a decentralized computing infrastructure that executes a virtual machine, referred to as the Ethereum virtual machine (EVM), to execute transactions on a chain. The EVM can be described as a global singleton and operates as a single-instance computer, globally across nodes of the peer-to-peer network. That is, each node in the network executes a local copy of the EVM to execute transactions on the chain. The chain of the peer-to-peer network records the changing state of the EVM as transactions are processed. While Ethereum is referenced herein for purposes of illustration, it is contemplated that implementations of the present disclosure can be realized using any appropriate peer-to-peer network (e.g., networks that provide on-chain computing; EVM-compatible chains). Example peer-to-peer networks can include, without limitation, Arbitrum, Avalanche, Base, and Tron, among several others.

Executing transactions in peer-to-peer networks requires the consumption of technical resources (e.g., processing, memory). In other words, computational effort is expended. In the context of Ethereum, gas refers to a unit of measure of the amount of computational effort required to execute specific operations. To pay for a transaction, a transaction fee, referred to as a gas fee in Ethereum, is determined as the amount of gas used to perform operations of the transaction, multiplied by a cost per unit gas. The transaction fee is paid regardless of whether a transaction succeeds or fails. In Ethereum, transaction fees (gas fees) are paid in Ethereum's native cryptocurrency, which is referred to as ether (ETH).

In using digital assets as a means of exchange, users may have digital assets on one chain that they would like to use on another chain. For example, a user can seek to execute a transaction on a destination chain, but pay transaction fees for the transaction on the destination chain using a digital asset that is maintained on a source chain. To highlight this, a non-limiting illustrative example can be considered, which includes Alice transferring a digital asset (e.g., a NFT) to Bob on a destination chain. The transfer requires computational effort (in Ethereum, gas) to execute the transaction on the destination chain, which requires a transaction fee (in Ethereum, gas fee that is paid in ETH). In this example, Alice has an amount of cryptocurrency (e.g., stablecoin) in a source chain that is to be used to pay the transaction fee in the destination chain.

Such scenarios present multiple issues. For example, in a traditional approach, multiple transactions would need to be executed to facilitate the transaction on the destination chain. With continued reference to the non-limiting example above, Alice would have to bridge a sufficient amount of cryptocurrency from the source chain to cover the transaction fees on the destination chain. This bridging, however, can itself require multiple transactions and commensurate expenditure of technical resources, not to mention additional transaction fees. Further, Alice would have to initiate each of the multiple transactions from respective EOAs. This not only consumes resources on the device Alice uses, but also diminishes user experience (UX) (e.g., navigating between multiple EOAs and waiting for one transaction to complete before initiating a next transaction).

In view of the foregoing, implementations of the present disclosure are directed to facilitating digital asset transactions on a destination chain using cryptocurrency from a source chain. More particularly, implementations of the present disclosure enable cryptocurrency abstraction using a CCTP for use of the cryptocurrency from the source chain for payment of transaction fees on the destination chain. As described in further detail herein, implementations of the present disclosure use a non-optimistic pull approach that is based on a permit granted by the user. In this manner, the user is able to initiate a single transaction on the destination chain and have cryptocurrency transferred from the source chain to account for transaction fees on the destination chain using CCTP.

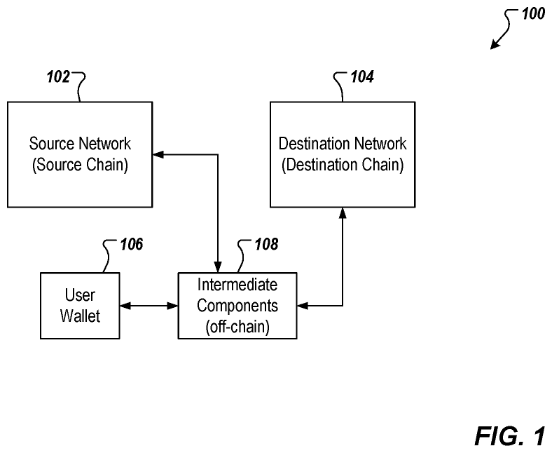

FIG. 1 depicts a conceptual architecture 100 in accordance with implementations of the present disclosure. The conceptual architecture 100 includes a source network 102, a destination network 104, a user wallet 106 (e.g., used to access one or more EOAs), and a set of intermediate components 108. The source network 102 can include a peer-to-peer network that provides on-chain computing and maintains a source chain. The destination network 104 can include a peer-to-peer network that provides on-chain computing and maintains a destination chain. In some examples, the source network 102 and the destination network 104 can be referred to as the source chain and the destination chain, respectively.

In some implementations, a user (e.g., an owner of the user wallet 106) seeks execution of a digital asset transaction on the destination network, which will incur computational effort that is to be accounted for by a transaction fee. In accordance with implementations of the present disclosure, the source network 102 maintains a cryptocurrency that is to be used to pay the transaction fee on the destination network 104. The conceptual architecture 100 is configured to provide cryptocurrency abstraction using a CCTP to enable cryptocurrency of the source network 102 to be used for transaction fees in the destination network 104.

To illustrate, a non-limiting example can be considered, in which the user has a digital asset (e.g., a NFT) on the destination network 104 that the user would like to transfer to another user. Within the destination network, the transaction to transfer the digital asset expends computational effort (e.g., executing operations and recording the transaction to the destination chain), which is accounted for by a transaction fee. In this example, the user has a first cryptocurrency (e.g., USDC™) on the source network 102 that is to be used to pay the transaction fee on the destination network 104. This is an example of cryptocurrency abstraction (in Ethereum, referred to as gas abstraction), which refers to use of a non-native cryptocurrency to pay transaction fees. Here, non-native refers to a cryptocurrency that is not native to the chain that the cryptocurrency is being used on to pay transaction fees. By way of non-limiting example, the native cryptocurrency of the destination chain can be ETH, but USDC™, which is non-native from the perspective of the destination chain, is transferred from the source network (using the CCTP, as described in more detail herein) to the destination chain for payment of the transaction fees. In this manner, converting the non-native cryptocurrency to the native cryptocurrency is avoided, thereby conserving computation resources.

As described in further detail herein, implementations of the present disclosure provide cryptocurrency abstraction using a CCTP. For example, a CCTP is executed across the source network 102 and the destination network 104 to enable a cryptocurrency (e.g., USDC™) on the source network 102 to be used to pay transaction fees on the destination network 104. While aspects of the CCTP are discussed herein, further detail on the CCTP is provided in commonly assigned U.S. application Ser. No. 18/127,583, filed on Mar. 28, 2023, and entitled BRIDGING BLOCKCHAINS, the disclosure of which is expressly incorporated herein by reference in the entirety for all purposes.

In general, the CCTP can be described as a permissionless on-chain utility that facilitates cryptocurrency transfers securely between blockchains using burning and minting. The CCTP can be described with reference to FIG. 1, where a user initiates (e.g., from the user wallet 106) a transfer of a specified amount of a cryptocurrency from the source network 102 to the destination network 104 and specifies a recipient wallet address on the destination network 104. Here, the specified amount is accounted for in a number of tokens (e.g., coins) of the cryptocurrency that is equal to the specified amount. The tokens of the cryptocurrency are burned on the source network 102. Burning refers to permanently removing the tokens from circulation. The provider of the cryptocurrency observes and attests to the burn event on the source network 102 and provides an attestation, which provides authorization to mint new tokens in the specified amount of cryptocurrency on the destination network 104. Minting refers to generating new tokens of the cryptocurrency. The attestation is used to trigger minting of the new tokens equaling the specified amount on the destination network 104 and sending the tokens to the recipient wallet address within the destination network 104.

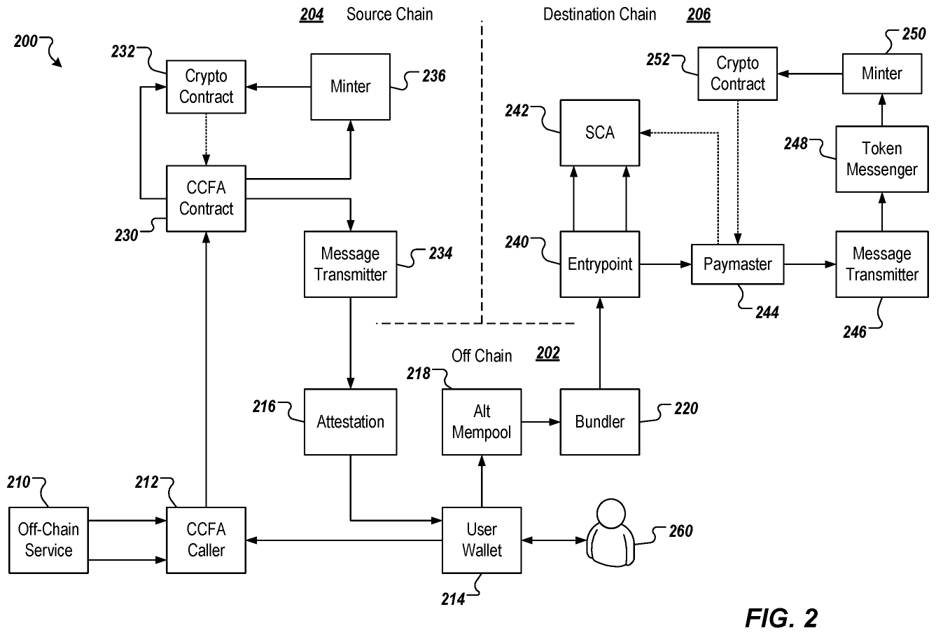

FIG. 2 depicts an example architecture 200 to facilitate cryptocurrency abstraction using a CCTP in accordance with implementations of the present disclosure. In the example of FIG. 2, the architecture 200 includes an off-chain network 202, a source chain network 204, and a destination chain network 206. The off-chain network 202 represents components that are executed off-chain (e.g., one or more computing devices that are independent of a chain network), the source chain network 204 represents components that are executed on a source chain (e.g., of the source network 102 of FIG. 1), and the destination chain network 206 represents components that are executed on a destination chain (e.g., of the destination network 104 of FIG. 1). In the example of FIG. 2, dashed arrows indicate transfers of cryptocurrency between components.

In the example of FIG. 2, the off-chain network 202 includes an off-chain service 210, a cross-chain fee abstraction (CCFA) caller 212, a user wallet 214, an attestation service 216, an alternative memory pool (alt mempool) 218, and a bundler 220. In some examples, the off-chain service 210 provides estimates for source chain transaction fees and/or estimates for destination chain transaction fees to the CCFA caller 212. The source chain transaction fee estimate is an estimate of a transaction fee for executing operations on the source chain of the source chain network 204 and the destination transaction fee estimate is an estimate of a transaction fee for executing operations on the destination chain of the destination chain network 206. For example, and in the context of Ether, a so-called gas price oracle can estimate a current gas price based on data collected from multiple sources (e.g., public nodes, validators, exchanges, and the like) and can simulate a transaction on the EVM to estimate an amount of gas the transaction incurs. The source chain transaction fee estimate can be determined by multiplying the estimated gas fee price by the estimated amount of gas.

In some examples, the CCFA caller 212 initiates operations for cryptocurrency abstraction using the CCTP, as described in further detail herein. In the context of Ethereum, the CCFA caller 212 can be referred to as a cross-chain gas abstraction (CCGA) caller. In some examples, the user wallet 214 is an off-chain program that stores private keys of a user 260, each private key corresponding to an account of the user 260 on the source chain and/or the destination chain.

In some examples, the alt mempool 218 serves as off-chain storage for user operations that are to be executed on the destination chain. At a high-level, the alt mempool 218 can be described as a memory pool that holds pending user operations that have not been picked up for execution by the bundler 220. Although a single bundler is depicted, multiple bundlers can be included. The alt mempool 218 can be described as an alternative to (is different from) so-called canonical memory pools that are used to hold user operations for respective nodes of the destination chain network 206. For example, alt mempools can include specific rules that are to be observed. An example rule of the alt mempool 218 can include, without limitation, that the alt mempool 218 prevents multiple SCAs from reading and writing to the same nonce. Another example rule of the alt mempool 218 can include, without limitation, the paymaster 244 being included on a whitelist of paymasters. Further details of alternative memory pools are provided in Ethereum Request for Comment (ERC) 4337 (ERC-4337), which is incorporated herein by reference in the entirety for all purposes. In some examples, the bundler 220 retrieves user operations from the alt mempool 218 to initiate execution of respective transactions on the destination chain. The bundler 220 listens to user operations added to the alt mempool 218 and packages and sends user operations as regular transactions to nodes of the destination network of the destination chain network 206.

In the example of FIG. 2, the source chain network 204 includes a CCFA contract 230, a cryptocurrency contract 232, a message transmitter 234, and a minter 236. In some examples, the CCFA contract 230 is provided as a smart contract. Smart contracts can be described as programs that are executed on-chain and are each provided as a collection of code (functions) and data (state) that resides at a specific address on the chain. In the example of FIG. 2, the CCFA contract 230 resides at a specific address on the source chain of the source chain network 202. In some examples, the cryptocurrency contract 232 is a smart contract that represents tokens of the cryptocurrency and facilitates transactions implicating the tokens, as described in further detail herein. In some examples, the message transmitter 234 is a smart contract that executes generic message passing. For example, the message transmitter 234 sends messages on the source chain and receives messages on the destination chain. In the CCTP, the message transmitter 234 transmits an attestation request to the attestation service 216, as described in further detail herein. In some examples, the minter 236 is a smart contract that can mint and/or burn tokens of the cryptocurrency (e.g., to facilitate execution of the CCTP), as described in further detail herein.

In the example of FIG. 2, the destination chain network 206 includes an entrypoint 240, a SCA 242, a paymaster 244, a message transmitter 246, a token messenger 248, a minter 250, and a cryptocurrency contract 252. In some examples, the entrypoint 240 is a smart contract that receives a bundle of userOps from the bundler 220 and, for each userOp in the bundle, performs validation before enabling execution of the userOp. In some examples, the paymaster 244 is a smart contract that facilitates payment of transaction fees in the destination network on behalf of users. For example, and as described in further detail herein, the paymaster 244 is programmed to accept transaction fees in a non-native cryptocurrency (e.g., USDC™) in place of the native cryptocurrency (e.g., ETH) of the destination network. Further detail on paymasters is provided in ERC-4337, introduced above.

In some examples, the message transmitter 246 is a smart contract that is the corollary on the destination chain network 206 of the message transmitter 234 on the source chain network 204. For example, during execution of the CCTP, the message transmitter 246 receives a message from the source chain network 204, as described in further detail herein. In some examples, the token messenger 248 is a smart contract that functions as an entry point for cross-chain cryptocurrency transfer and routes messages to mint new tokens of the cryptocurrency on the destination chain.

In some examples, the minter 250 is a smart contract that can mint and/or burn tokens of the cryptocurrency (e.g., to facilitate execution of the CCTP), as described in further detail herein. Here, it can be noted that the minter 236 and the minter 250 are each provided by the enterprise that manages the cryptocurrency that is being abstracted, and execute to mint and/or burn the cryptocurrency on the respective chains.

As described in further detail herein, the example architecture 200 enables the user 260 to initiate cryptocurrency abstraction using the CCTP in accordance with implementations of the present disclosure. For example, the user 260 is able to use cryptocurrency stored on the source chain of the source chain network 204 to account for transaction fees for transactions executed on the destination chain network 206. Here, the user 260 is the owner of the user wallet 214.

Prior to initiating any cross-chain transfer of cryptocurrency, the user 260 generates an off-chain signature, referred to as a permit signature, that is used to enable components to post transactions on behalf of the user, which transactions do not incur transaction fees (e.g., referred to gasless transactions). The permit signature is provided using a permit function (permit ( ) and provides approval for a component, referred to as a spender, to pay transaction fees on the user's behalf. Further detail on off-chain signatures is provided in Ethereum Improvement Proposal 2612 (EIP-2612), which is incorporated herein by reference in the entirety for all purposes. In the example of FIG. 2, the permit signature is provided to the CCFA caller 212. It can be noted that generation of the off-chain signature need only be executed once, and the resulting permit signature can be used for multiple cross-chain cryptocurrency transfers.

In some examples, the CCFA caller 212 can be any appropriate entity that can call an initiateCCFA ( ) function of the CCFA contract 230. For example, and without limitation, the CCFA caller 212 can be a third-party application, the user wallet 214, or a distributed application (dAPP) used by the user 260.

In accordance with implementations of the present disclosure, the CCFA caller 212 initiates a transaction to abstract cryptocurrency of the source chain network 204 for payment of transaction fees on the destination chain network 206. In some examples, the call to the CCFA contract 230 includes amount(s) of cryptocurrency to transfer and the permit signature. In some examples, the amount(s) of cryptocurrency includes estimate(s) from the off-chain service 210. For example, this can include a destination chain transaction fee estimate. As another example, this can include a source chain transaction fee estimate and a destination chain transaction fee estimate.

In response to the call, the CCFA contract 230 initiates CCTP burn. For example, the permit function is called using the permit signature to enable the CCFA contract 230 to pull cryptocurrency from the user 260. In some examples, if the CCFA caller 212 is not the user 260, the CCFA contract 230 calls a transferFrom ( ) function to move an amount of the cryptocurrency equivalent to the source chain gas fee from the user 260 to the CCFA caller 212 (e.g., from the cryptocurrency contract 232 of the user 260 to a cryptocurrency store of the CCFA caller 212). This refunds the CCFA caller 212 for any transaction fees on the source chain network 204. In some examples, a depositForBurn ( ) function is implemented in the CCFA contract 230, which deposits and burns tokens from the CCFA contract 230 to be minted on the destination chain network 206, as described in further detail herein. In this manner, an additional transfer of the cryptocurrency (and commensurate consumption of computing resource) is avoided.

The CCFA contract 230 calls a burn ( ) function of the minter 236, which burns tokens in the amount of the destination transaction fee, as provided in the destination chain transaction fee estimate. In response, the minter 236 instructs the cryptocurrency contract 232 to burn the tokens. The CCFA contract 230 calls a sendMessage ( ) function of the message transmitter 234, which generates a message event (messageSent) that is attested to by the attestation service 216. In some examples, the sendMessage ( ) function includes parameters of destinationDomain (an identifier uniquely identifying the destination network), recipient (an address of a smart contract that is to receive the message in the destination domain), and messageBody (an application-specific message to be handled by the recipient). In response to the message event, the attestation service 216 generates an attestation (e.g., a message hash), which evidences that a number of tokens equal to the (estimated) destination transaction fee have been burned in the source chain network 204. The user wallet 214 retrieves the attestation from the attestation service 216. For example, the user wallet 214 calls GET . . . /v1/attestations/{messagehash} to get the attestation from the attestation service 216.

The user wallet 214 triggers execution of a transaction in the destination network by sending a user operation to the alt mempool 218. The user operation is signed using the private key of the user 260 and includes a paymasterAndData parameter (userop(paymasterAndData)). In some examples, the paymaster part of the parameter identifies the paymaster 244 as the paymaster that is to be used to execute the transaction and pay the transaction fees on behalf of the user 260. For example, the paymaster part of the parameter includes an address of the paymaster 244 within the domain network. In some examples, the paymaster 244 can be provided by the enterprise that manages the cryptocurrency that is being abstracted and is to be used to pay the transaction fee on the destination chain network 206. It is contemplated, however, that the paymaster 244 can be provided by any appropriate entity. To signal to the paymaster 244 that the CCTP is being used, the attestation is provided in the data part of the parameter.

The bundler 220 retrieves the user operation from the alt mempool 218. In some examples, the bundler 220 executes a validation of the user operation. In some examples, validation includes validating input parameters of the user operation, simulating the user operations and validating a resulting trace. Further detail on validation of user operations is provided in ERC-4337. In some examples, validation further includes specifications that are unique to the alt mempool 218. In response to validation of the user operation, the bundler 220 submits the user operation to the destination chain when calling the entrypoint 240.

The entrypoint 240 validates the user operation and the paymaster 244. Further detail on validation of the user operation and the paymaster is provided in ERC-4337. In some examples, concurrent with validation of the paymaster 244, the attestation is provided to the message transmitter 246 by the paymaster 244 and a receiveMessage( ) function is called on the message transmitter 246. In this manner, the message transmitter 246 receives the message event indicating the amount of the cryptocurrency that has been burned on the source chain network 204, the message event being attested to by the attestation. In response to the message event, a handleReceiveMessage( ) function of the token messenger 248 is called, which triggers minting of the equivalent amount of the cryptocurrency by the token minter 250. For example, the token minter 250 executes a mint function call to the cryptocurrency contract 252, which mints the tokens and transfers the tokens to the paymaster 244. In this manner, the paymaster 244 holds a sufficient amount of the cryptocurrency to account for transaction fees for execution of the underlying transaction (e.g., transferring a NFT from Alice to Bob) on the destination chain network 206.

In response to the entrypoint 240 validating both the user operation and the paymaster, the entrypoint 240 initiates execution the user operation to effect the transaction on the domain chain side 206 (e.g., transfer the NFT from Alice (the SCA 242) to Bob (another SCA)). The amount of computing resources (in Ethereum, gas) expended in executing the transaction is determined. After execution of the transaction, the entrypoint 240 makes a postOp call to the paymaster 244, which indicates the transaction fee for execution of the transaction. The paymaster 244 pays the transaction fee in the cryptocurrency that is native to the domain chain side 206 (e.g., ETH). In some examples, the paymaster 244 holds a sufficient pool of the native cryptocurrency to account for the transaction fees. In some examples, the paymaster 244 converts at least a portion of the non-native cryptocurrency (e.g., USDC™) (the newly minted tokens received from the cryptocurrency contract 252) into the native currency (e.g., ETH) to account for the transaction fee. In some examples, any remaining non-native cryptocurrency (e.g., USDC™) is refunded by the paymaster 244 (e.g., to the SCA 232).

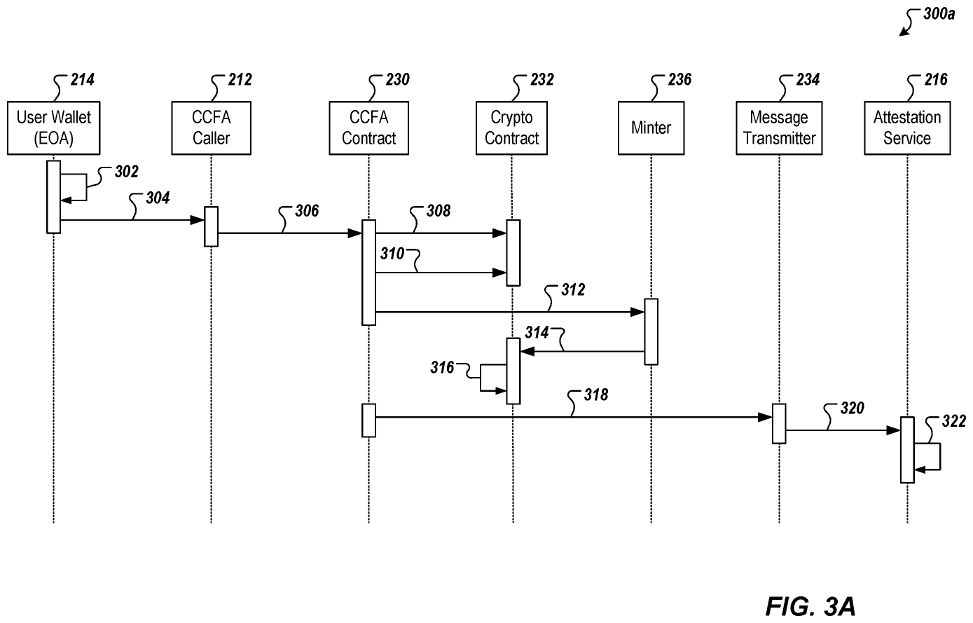

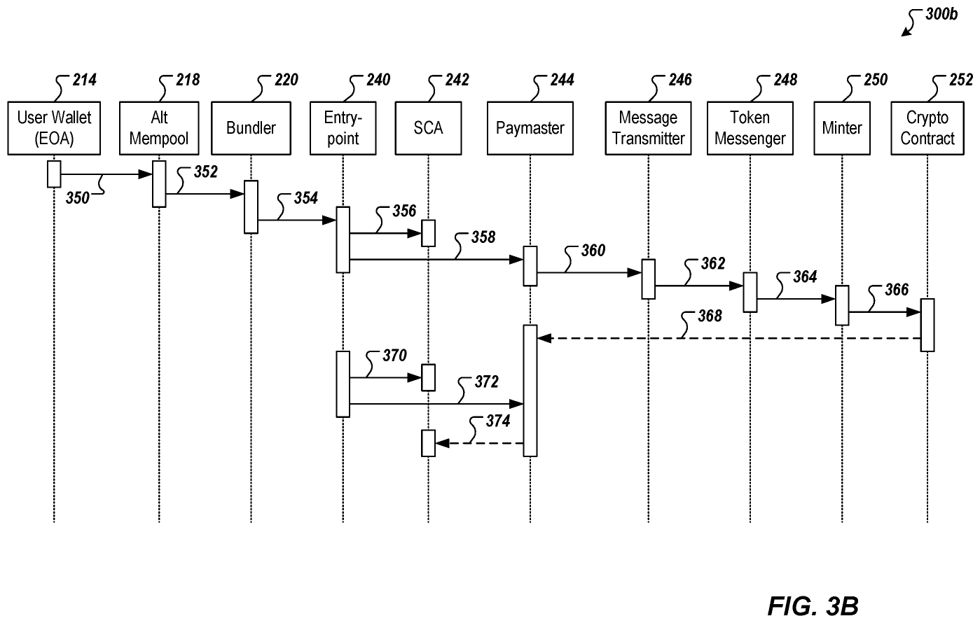

FIG. 3A is an example signal flow diagram 300a for the source chain network in accordance with implementations of the present disclosure. The example signal flow diagram 300a of FIG. 3 represents a portion of the CCTP for cryptocurrency abstraction to provide cryptocurrency from a source chain (e.g., the source chain network 204 of FIG. 2) for transaction fees incurred on a destination chain (e.g., the destination chain network 206 of FIG. 2). In some examples, the signal flow diagram 300a represents burning of tokens of the cryptocurrency on the source chain.

In the example of FIG. 3A, the user wallet 214 generates (302) a permit signature. As discussed in detail herein, the permit signature is generated once and can be used by the user for multiple instances of cryptocurrency abstraction using CCTP. The user wallet 214 provides (306) the permit signature to the CCFA caller 212. The CCFA caller 212 calls (306) the initiateCCFA function of the CCFA contract 230. The CCFA contract 230 calls (308) a permit function using the permit signature to enable the CCFA contract 230 to pull cryptocurrency from the cryptocurrency contract 232. In some examples, the CCFA contract 230 calls (310) a transfer function to transfer (pull) a sufficient amount of cryptocurrency to cover transaction fees on the source chain network 204 (e.g., transfer to an account of the entity that operates the CCFA caller 212). The CCFA contract 232 calls (312) a burn function of the minter 236, which calls (314) a burn function to burn tokens of the cryptocurrency. The cryptocurrency contract 232 burns (316) the tokens. In some examples, the number of tokens burned is equivalent to the estimated destination transaction fee. The CCFA contract calls (318) a send message function of the message transmitter 234, which emits (320) a message event that is descriptive of the token burn on the source chain network 204. The attestation service 216 receives the message event and generates (322) an attestation that evidences the token burn on the source chain network 204.

FIG. 3B is an example signal flow diagram 300b for the destination chain network in accordance with implementations of the present disclosure. The example signal flow diagram 300b of FIG. 3B represents a portion of the CCTP for cryptocurrency abstraction to provide cryptocurrency from a source chain (e.g., the source chain network 204 of FIG. 2) for transaction fees incurred on a destination chain (e.g., the destination chain network 206 of FIG. 2). In some examples, the signal flow diagram 300b represents execution of the transaction and minting of tokens of the cryptocurrency on the destination chain.

The user wallet 214 submits (350) a user operation to the alt mempool 218, the user operation triggering execution of a transaction on the destination chain network 206 (e.g., transferring a NFT between user accounts), identifies the paymaster 244 that is to be used and includes the attestation. Although not depicted in FIG. 3B, prior to submitting the user operation, the user wallet 214 retrieves the attestation from the attestation service 216.

The bundler requests and receives (352) the user operation from the alt mempool 218. The bundler 220 submits (354) the user operation to the entrypoint 240. Although not depicted in FIG. 3B, the bundler 220 can validate the user operation before submitting the user operation to the entrypoint 240. The entrypoint 240 validates (356) the user operation with the SCA 242 and validates (358) the paymaster 244. The paymaster 244 calls (360) a receive message function of the message transmitter, which receives the message event and the attestation. The message transmitter calls (362) a handle message function of the token messenger 248, which instructs (364) the minter 250 to call a mint function. The minter 250 calls (366) the mint function of the cryptocurrency contract 232, which mints tokens of the cryptocurrency and transfers the minted tokens to the paymaster 244. In some examples, the number of tokens minted is equivalent to the estimated destination transaction fee.

The entrypoint 240 executes (370) the transaction on the destination chain (e.g., transfer a NFT between users) and posts (372) execution of the operation to the paymaster 244, which provides an amount of computing resources expended to execute the transaction (in Ethereum, gas). The paymaster 244 pays the transaction fee (determined based on the amount of computing resources expended) and, if necessary, refunds (374) cryptocurrency to the SCA 242.

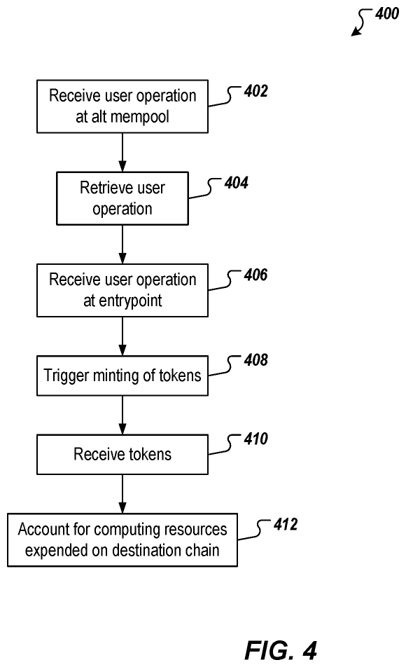

FIG. 4 depicts a flowchart of an example process 400 that can be executed in accordance with implementations of the present disclosure. The example process 400 can be executed for cryptocurrency abstraction using a CCTP between a source chain network and a destination chain network.

A user operation is received at an alt mempool (402). For example, and as described herein with reference to FIG. 2, the user wallet 214 triggers execution of a transaction in the destination network by sending the user operation to the alt mempool 218. The user operation is signed using the private key of the user 260 and includes a paymasterAndData parameter (userop (paymasterAndData)). In some examples, the paymaster part of the parameter identifies the paymaster 244 as the paymaster that is to be used to execute the transaction and pay the transaction fees on behalf of the user 260, and the attestation is provided in the data part of the parameter.

The user operation is retrieved (404). For example, and as described herein, the bundler 220 retrieves the user operation from the alt mempool 218 and executes a validation of the user operation. In some examples, validation includes validating input parameters of the user operation, simulating the user operations and validating a resulting trace. The user operation is received at an entrypoint (406). For example, and as described herein, in response to validation of the user operation, the bundler 220 submits the user operation to the destination chain by calling the entrypoint 240. The entrypoint 240 validates the user operation and the paymaster 244.

Minting of tokens is triggered (408). For example, and as described herein, while the paymaster 244 is being validated, the attestation is provided to the message transmitter 246 by the paymaster 244 and a receiveMessage ( ) function is called on the message transmitter 246. In this manner, the message transmitter 246 receives the message event indicating the amount of the cryptocurrency that has been burned on the source chain network 204, the message event being attested to by the attestation. In response to the message event, a handleReceiveMessage ( ) function of the token messenger 248 is called, which triggers minting of the equivalent amount of the cryptocurrency by the token minter 250 calling a mint function of the cryptocurrency contract 252.

Tokens are received (410). For example, and as described herein, the tokens are transferred to the paymaster 244 from the cryptocurrency contract 252. In this manner, the paymaster 244 holds a sufficient amount of the cryptocurrency to account for transaction fees for execution of the underlying transaction (e.g., transferring a NFT from Alice to Bob) on the destination chain network 206. Computing resources expended on the destination chain are accounted for (412). For example, and as described herein, in response to the entrypoint 240 validating both the user operation and the paymaster, the entrypoint 240 initiates execution the user operation to effect the transaction on the domain chain side 206 (e.g., transfer the NFT from Alice (the SCA 242) to Bob (another SCA)). The amount of computing resources (in Ethereum, gas) expended in executing the transaction is determined. After execution of the transaction, the entrypoint 240 makes a postOp call to the paymaster 244, which indicates the transaction fee for execution of the transaction. The paymaster 244 pays the transaction fee in the cryptocurrency that is native to the domain chain side 206 (e.g., ETH).

Implementations of the present disclosure provide multiple technical improvements. For example, and continuing with the non-limiting example above, Alice wants to transfer a digital asset to Bob on a destination chain. This transaction incurs transaction fees that have to be paid in a native cryptocurrency (e.g., ETH) of the destination chain. In this example, Alice is to pay for the transaction fees on the destination chain using a cryptocurrency on a source chain, the cryptocurrency (e.g., USDC™) being non-native to the destination chain. In a traditional approach, Alice would have to initiate a transaction to convert the non-native cryptocurrency into the native cryptocurrency on the destination chain, which expends computing resources and itself incurs transaction fees. After obtaining the native cryptocurrency, Alice separately initiates the transaction to transfer the digital asset, which expends additional computing resources incurring transaction fees paid for in the converted, native cryptocurrency. Accordingly, in the traditional approach, is resource-inefficient in that multiple transactions are executed by Alice with their commensurate consumption of computing resources. Further, Alice needs to execute multiple interactions with multiple accounts (e.g., interact with one SCA to convert cryptocurrency, interact with another SCA to execute the digital asset transfer). This is not only non-optimal from a UX perspective, but expends computing resources on the device(s) Alice uses.

As described in detail herein, implementations of the present disclosure enable cryptocurrency abstraction using a CCTP to obviate at least the above-discussed technical deficiencies of the traditional approach. For example, and continuing with the non-limiting example above, cryptocurrency abstraction with the CCTP enable, from Alice's perspective, Alice's non-native cryptocurrency on the source chain to account for transaction fees on destination chain. This is without requiring Alice to initiate execution of multiple transactions (improving Alice's UX) and their commensurate consumption of computing resources both on-chain and on device(s) Alice uses.

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification can be realized in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs (i.e., one or more modules of computer program instructions) encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. The program instructions can be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry (e.g., an FPGA (field programmable gate array) or an ASIC (application-specific integrated circuit)). The apparatus can optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry (e.g., a FPGA, an ASIC), or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer can be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification can be provisioned on a computer having a display device (e.g., a CRT (cathode ray tube) or LCD (liquid crystal display) monitor) for displaying information to the user and a keyboard and a pointing device (e.g., a mouse, a trackball), by which the user can provide input to the computer. Other kinds of devices can be used to provide for interaction with a user as well; for example, feedback provided to the user can be any form of sensory feedback (e.g., visual feedback, auditory feedback, tactile feedback); and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device (e.g., a smartphone that is running a messaging application), and receiving responsive messages from the user in return.

Implementations of the subject matter described in this specification can be realized in a computing system that includes a back-end component (e.g., as a data server) a middleware component (e.g., an application server), and/or a front-end component (e.g., a client computer having a graphical user interface, a web browser, or an app through which a user can interact with implementations of the subject matter described in this specification, or any combination of one or more such back-end, middleware, or front-end components. The components of the system can be interconnected by any form or medium of digital data communication (e.g., a communication network). Examples of communication networks include a local area network (LAN) and a wide area network (WAN) (e.g., the Internet).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) can be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for cryptocurrency abstraction using a cross-chain transfer protocol (CCTP) between a source chain network and a destination chain network, comprising:
receiving a user operation that indicates a paymaster and that comprises an attestation;
triggering, by the paymaster, minting of a number of tokens of a cryptocurrency on a destination chain, the number of tokens corresponding to a number of tokens of the cryptocurrency burned on a source chain attested to by the attestation;
receiving, by the paymaster, the number of tokens of the cryptocurrency minted on the destination chain; and
accounting, by the paymaster and using at least a portion of the number of tokens of the cryptocurrency, for computing resources expended on the destination chain to execute a transaction of the user operation.

2. The computer-implemented method of claim 1, wherein a bundler retrieves the user operation from an alternative memory pool and provides the user operation to an entrypoint.

3. The computer-implemented method of claim 1, wherein a cross-chain fee abstraction contract triggers burning of the number of tokens on the source chain based on a permit signature provided by a user that owns the number of tokens on the source chain.

4. The computer-implemented method of claim 3, wherein the cross-chain fee abstraction contract transfers tokens of the cryptocurrency from an account of the user on the source chain to account for computing resources expended on the source chain.

5. The computer-implemented method of claim 1, wherein the attestation is generated by an attestation service in response to a message event provided from the source chain.

6. The computer-implemented method of claim 1, wherein a user wallet of the user receives the attestation from an attestation service and transmits the user operation to the alternative memory pool.

7. The computer-implemented method of claim 1, further comprising providing, by the paymaster, one or more tokens to a user account of a user on the destination chain.

8. The computer-implemented method of claim 1, wherein the paymaster triggers minting of the number of tokens of a cryptocurrency on the destination chain in response to a validate paymaster function called by an entrypoint.

9. A non-transitory computer-readable storage medium coupled to one or more processors and having instructions stored thereon which, when executed by the one or more processors, cause the one or more processors to perform operations for cryptocurrency abstraction using a cross-chain transfer protocol (CCTP) between a source chain network and a destination chain network, the operations comprising:
receiving a user operation that indicates a paymaster and that comprises an attestation;
triggering, by the paymaster, minting of a number of tokens of a cryptocurrency on a destination chain, the number of tokens corresponding to a number of tokens of the cryptocurrency burned on a source chain attested to by the attestation;
receiving, by the paymaster, the number of tokens of the cryptocurrency minted on the destination chain; and
accounting, by the paymaster and using at least a portion of the number of tokens of the cryptocurrency, for computing resources expended on the destination chain to execute a transaction of the user operation.

10. The non-transitory computer-readable storage medium of claim 9, wherein a bundler retrieves the user operation from an alternative memory pool and provides the user operation to an entrypoint.

11. The non-transitory computer-readable storage medium of claim 9, wherein a cross-chain fee abstraction contract triggers burning of the number of tokens on the source chain based on a permit signature provided by a user that owns the number of tokens on the source chain.

12. The non-transitory computer-readable storage medium of claim 11, wherein the cross-chain fee abstraction contract transfers tokens of the cryptocurrency from an account of the user on the source chain to account for computing resources expended on the source chain.

13. The non-transitory computer-readable storage medium of claim 9, wherein the attestation is generated by an attestation service in response to a message event provided from the source chain.

14. The non-transitory computer-readable storage medium of claim 9, wherein a user wallet of the user receives the attestation from an attestation service and transmits the user operation to the alternative memory pool.

15. The non-transitory computer-readable storage medium of claim 9, wherein operations further comprise providing, by the paymaster, one or more tokens to a user account of a user on the destination chain.

16. A system, comprising:
a computing device; and
a computer-readable storage device coupled to the computing device and having instructions stored thereon which, when executed by the computing device, cause the computing device to perform operations for cryptocurrency abstraction using a cross-chain transfer protocol (CCTP) between a source chain network and a destination chain network, the operations comprising:
receiving a user operation that indicates a paymaster and that comprises an attestation;
triggering, by the paymaster, minting of a number of tokens of a cryptocurrency on a destination chain, the number of tokens corresponding to a number of tokens of the cryptocurrency burned on a source chain attested to by the attestation;
receiving, by the paymaster, the number of tokens of the cryptocurrency minted on the destination chain; and
accounting, by the paymaster and using at least a portion of the number of tokens of the cryptocurrency, for computing resources expended on the destination chain to execute a transaction of the user operation.

17. The system of claim 16, wherein a bundler retrieves the user operation from an alternative memory pool and provides the user operation to an entrypoint.

18. The system of claim 16, wherein a cross-chain fee abstraction contract triggers burning of the number of tokens on the source chain based on a permit signature provided by a user that owns the number of tokens on the source chain.

19. The system of claim 18, wherein the cross-chain fee abstraction contract transfers tokens of the cryptocurrency from an account of the user on the source chain to account for computing resources expended on the source chain.

20. The system of claim 16, wherein the attestation is generated by an attestation service in response to a message event provided from the source chain.
